(19) United States
(12) Patent Application Publication
(10) Pub. No.: US 2026/0278333 A1
(43) Pub. Date: Sep. 17, 2026

(54) ARTIFICIAL INTELLIGENCE DEVICE FOR PROMPT-DRIVEN NEURO-SYMBOLIC AGENT AND METHOD THEREOF

(71) Applicant: LG ELECTRONICS INC., Seoul (KR)

(72) Inventor: Manasa BHARADWAJ, Toronto (CA)

(73) Assignee: LG ELECTRONICS INC., Seoul (KR)

(21) Appl. No.: 19/566,585

(22) Filed: Mar. 13, 2026

Related U.S. Application Data
(60) Provisional application No. 63/771,685, filed on Mar. 14, 2025.

(51) Int. Cl. G06N 3/042; G06F 16/2458; G06N 3/082

(52) U.S. Cl. CPC G06N 3/042; G06F 16/2471; G06N 3/082

(57) ABSTRACT

A method for controlling an artificial intelligence (AI) device can include receiving a user query indicating a target task and an observation from a target environment, obtaining a set of domain constraints, a set of contextual priors, and state information based on the user query and the observation, constructing an aggregated prompt sequence that fuses the user query and the observation with the set of domain constraints, the set of contextual priors, and the state information, generating, by a large language model, an action based on the aggregated prompt sequence, and outputting the action for execution within the target environment. Also, the set of domain constraints and the set of contextual priors can restrict an available action space of the large language model to prevent execution of impossible or contextually invalid operations.

### CROSS-REFERENCE TO RELATED APPLICATIONS

This non-provisional application claims priority under 35 U.S.C. § 119(e) to U.S. Provisional Application No. 63/771,685, filed on Mar. 14, 2025, the entirety of which is hereby expressly incorporated by reference into the present application.

### BACKGROUND

### Field

The present disclosure relates to a device and method for controlling an autonomous large language model (LLM) agent to execute complex sequential tasks within a defined environment, in the field of artificial intelligence (AI). Particularly, the method can implement a neuro-symbolic framework that dynamically retrieves and aggregates domain-specific constraints or rules, commonsense spatial priors or contextual relational priors, and progress tracking to provide highly structured prompts that constrain the LLM to generate valid and logically progressive actions.

### Discussion of the Related Art

Artificial intelligence (AI) has seen significant advancements, particularly with the development of Large Language Models (LLMs). These models have evolved from simple text generators into sophisticated autonomous agents tasked with executing complex, multi-step tasks. These LLM agents are increasingly being deployed to navigate and interact with a wide range of real-world physical and digital environments.

Despite their growing capabilities, these LLM agents often fail to grasp the physical and logical realities of their operating environments. For example, existing systems typically process a user's query relying solely on statistical text prediction without a foundational understanding of the environment's physical rules or domain constraints. Accordingly, the outputs often include proposed actions that are logically invalid or physically impossible, which can lead to task failure, unpredictable agent behavior and a suboptimal user experience.

This lack of environmental grounding and working memory is a significant limitation. For example, when tasked with locating and manipulating an object, an unconstrained LLM agent may attempt to interact with non-manipulatable elements (e.g., attempting to open a television or click unclickable text) or blindly search an entire environment without utilizing contextual relational priors (e.g., searching a bedroom for a frying pan).

Further, because conventional LLMs possess limited contextual memory, they frequently lose track of their overarching goals during long horizon tasks. This often forces the agent into repetitive error loops (e.g., such as repeatedly attempting to open a container that is already open) or taking a wastefully high number of steps to complete a task.

Further challenges exist due to the absence of a robust framework for dynamically tracking progress and filtering generated actions prior to execution. Conventional LLM agents typically send unconstrained outputs directly to an execution environment or rely on computationally expensive model fine-tuning to correct behavioral drift. However, these methods fail to capture the real-time progression of a multi-step task. Existing methods lack a systematic, programmatic way to seamlessly aggregate domain-specific constraints, inject commonsense knowledge, and evaluate milestone completion to continuously guide a language model toward successful task resolution.

Thus, a need exists for an improved method and device that can enable large language model agents to execute complex, multi-step tasks in a manner that is strictly grounded in the physical and logical realities of a specific environment.

Furthermore, a need exists for a framework that can dynamically track an agent's progress and maintain state awareness during task execution. Such a method is needed to move beyond the limited contextual memory of conventional LLMs and provide a robust, automated mechanism for evaluating milestone completion to ensure successful task resolution.

Also, a need exists for a comprehensive neuro-symbolic framework that can systematically generate valid and logically progressive actions by dynamically aggregating domain-specific constraints, contextual relational priors, and real-time state updates into highly structured prompts that guide the language model prior to execution.

### SUMMARY OF THE DISCLOSURE

The present disclosure has been made in view of the above problems and it is an object of the present disclosure to provide a device and method that can provide improved control and environmental grounding for autonomous large language model (LLM) agents executing complex, sequential tasks. Further, the method can provide enhanced task execution by implementing a neuro-symbolic framework that dynamically retrieves and aggregates domain-specific constraints and rules, contextual relational priors and commonsense knowledge, and progress tracking to constrain and guide the LLM to output valid and logically progressive actions.

An object of the present disclosure is to provide an artificial intelligence (AI) device and method for a neuro-symbolic agent framework that can execute complex, sequential tasks within a defined environment. The method can utilize a multi-component framework to systematically generate valid and logically progressive actions by grounding a large language model (LLM) in the operational realities of the target environment or domain. For example, a manager module acting as a central orchestration layer can first receive and parse a user query to identify a target domain and extract target objects. Then, the manager module can dynamically retrieve domain-specific constraints or rules from an environment constitution module, and extract contextual relational priors or commonsense knowledge from a commonsense augmentation module based on the extracted objects. Further, a progress tracking module can evaluate real-time environment observations against potential states using a state machine to calculate a next possible state and generate a progress statement. The manager module can subsequently compile these retrieved rules, priors and state updates into an aggregated augmented prompt to deeply constrain and guide the LLM reasoning engine in generating an executable action. This can produce a highly controlled and contextually aware execution trajectory for the autonomous agent while actively preventing invalid actions and repetitive error loops, thereby ensuring successful task resolution and enhancing overall system reliability.

Another object of the present disclosure is to provide a method for controlling an artificial intelligence (AI) device that can include receiving a user query indicating a target task and an observation from a target environment, obtaining a set of domain constraints, a set of contextual priors, and state information based on the user query and the observation, constructing an aggregated prompt sequence that fuses the user query and the observation with the set of domain constraints, the set of contextual priors, and the state information, generating, by a large language model, an action based on the aggregated prompt sequence, and outputting the action for execution within the target environment, in which the set of domain constraints and the set of contextual priors restrict an available action space of the large language model to prevent execution of impossible or contextually invalid operations.

It is another object of the present disclosure to provide a method, in which the obtaining the set of domain constraints, the set of contextual priors, and the state information includes parsing, by a manager module executed by the processor, the user query and the observation to extract an operational domain and at least one target entity, and querying a plurality of independent symbolic modules based on the operational domain and the at least one target entity.

Yet another object of the present disclosure is to provide a method, in which the set of domain constraints is retrieved from an environment constitution module and defines rules, unalterable physical laws or boundaries of the target environment, and the set of domain constraints prunes physically impossible actions from the available action space of the large language model.

An object of the present disclosure is to provide a method, in which the set of contextual priors is retrieved from a commonsense augmentation module including at least one of a lookup table, a database or a relational knowledge graph, and the set of contextual priors maps target objects to at least one of statistically probable locations, functional affordances, or relational prerequisites within the target environment to prevent contextually absurd actions or contextually absurd strategies.

Another object of the present disclosure is to provide a method, in which the state information is maintained by a progress tracking module configured as a finite state machine or programming logic, and the state information includes a sequential log of one or more of prior executed actions, current sub-goals, and intermediate thought checkpoints.

An object of the present disclosure is to provide a method, in which the constructing the aggregated prompt sequence further includes injecting a predefined list of permissible action templates and a plurality of few-shot examples configured to teach the large language model a structured reasoning format.

Yet another object of the present disclosure is to provide a method, in which the structured reasoning format mandates that the large language model alternates between generating an intermediate thought validating a sub-goal and outputting the action based on a strict syntax defined by one of the permissible action templates.

An object of the present disclosure is to provide a method that further includes receiving an updated observation from the target environment in response to the execution of the action, updating the state information based on the updated observation, obtaining an updated set of domain constraints, an updated set of contextual priors, and updated state information, constructing an updated aggregated prompt sequence based on the updated set of domain constraints, the updated set of contextual priors, and the updated state information, and generating a subsequent action based on the updated aggregated prompt sequence.

Another object of the present disclosure is to provide a method, in which the obtaining and the constructing are orchestrated by a meta large language model configured to dynamically evaluate the user query, autonomously retrieve the set of domain constraints and the set of contextual priors, and compile the aggregated prompt sequence before passing the aggregated prompt sequence to the large language model for inference.

An object of the present disclosure is to provide a method, in which the target environment is a real world physical environment and the action is output as a motor control signal to a robotic apparatus, or the target environment is a digital environment and the action is output as an automated web browser interaction.

Yet another object of the present disclosure is to provide a method, in which the state information includes an execution step count or a repeated action counter, and the method further includes monitoring the execution step count or the repeated action counter during execution of the target task, comparing the execution step count or the repeated action counter with a predetermined threshold number, and in response to determining that the execution step count or the repeated action counter exceeds the predetermined threshold number, modifying the aggregated prompt sequence to inject a corrective heuristic, in which the corrective heuristic forces the large language model to select an alternative action pathway to prevent the artificial intelligence device from entering an endless execution loop.

An object of the present disclosure is to provide a method, in which the observation from the target environment includes visual data, and the receiving the observation further includes processing the visual data through a vision-language model or an image encoder to extract a textual state description of the target environment, in which the textual state description identifies objects and spatial geometries within the target environment and is fused into the aggregated prompt sequence to ground the large language model in a current physical reality of the target environment.

Another object of the present disclosure is to provide a method that further includes in response to the target environment returning an error observation indicating that the action failed to execute successfully, updating the state information to flag the action as a failed operation for a current environmental state, and constructing a subsequent aggregated prompt sequence that includes the failed operation and instructs the large language model to bypass the failed operation during a subsequent inference cycle.

Another object of the present disclosure is to provide an artificial intelligence (AI) device including a memory configured to store information store information for a large language model, and a controller configured to receive a user query indicating a target task and an observation from a target environment, obtain a set of domain constraints, a set of contextual priors and state information based on the user query and the observation, construct an aggregated prompt sequence that fuses the user query and the observation with the set of domain constraints, the set of contextual priors, and the state information, generate, by the large language model, an action based on the aggregated prompt sequence, and output the action for execution within the target environment, in which the set of domain constraints and the set of contextual priors restrict an available action space of the large language model to prevent execution of impossible or contextually invalid operations.

An object of the present disclosure is to provide a non-transitory computer readable medium storing computer-executable instructions that when executed by a processor, cause the processor to perform the operations of receiving a user query indicating a target task and an observation from a target environment, obtaining a set of domain constraints, a set of contextual priors, and state information based on the user query and the observation, constructing an aggregated prompt sequence that fuses the user query and the observation with the set of domain constraints, the set of contextual priors, and the state information, generating, by a large language model, an action based on the aggregated prompt sequence, and outputting the action for execution within the target environment, in which the set of domain constraints and the set of contextual priors restrict an available action space of the large language model to prevent execution of impossible or contextually invalid operations.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example encoder-decoder based transformer architecture for a large language model according to an embodiment of the present disclosure.

FIG. 5 illustrates a block diagram of an AI agent architecture configured to interact with enterprise tools and data according to an embodiment of the present disclosure.

FIG. 6 illustrates an example of an autonomous agent performing tasks on a computer according to an embodiment of the present disclosure.

FIG. 7 illustrates an example of an autonomous agent performing tasks in a web shopping environment according to an embodiment of the present disclosure.

FIG. 8, including parts (a)-(d), illustrates an example comparison of error type distributions for different large language models according to related art models.

FIG. 9 illustrates a block diagram of a multi-component neuro-symbolic framework for an autonomous agent according to an embodiment of the present disclosure.

FIG. 10 illustrates an example flow chart for a method of controlling an AI device to implement a prompt-driven neuro-symbolic agent according to an embodiment of the present disclosure.

FIG. 11 illustrates an overview of a pipeline architecture comparing a baseline neural agent and a neuro-symbolic agent framework according to an embodiment of the present disclosure.

FIG. 12 illustrates an example table comparing environment constitution rules and environmental commonsense priors across different datasets according to embodiments of the present disclosure.

FIG. 13 illustrates an example table showing progress tracking and thought generation examples according to an embodiment of the present disclosure.

FIG. 14 illustrates an example set of environment constitution rules and constraints for an autonomous agent according to an embodiment of the present disclosure.

FIG. 15 illustrates an example table of spatial commonsense priors mapping objects to expected locations according to an embodiment of the present disclosure.

FIG. 16 illustrates an example set of task types, goals, and corresponding progress tracking patterns according to an embodiment of the present disclosure.

FIG. 17 illustrates an example base system prompt including action templates and few-shot examples for guiding an autonomous agent according to an embodiment of the present disclosure.

FIG. 18 illustrates an example task execution trajectory for an autonomous agent according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and biases input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user. For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

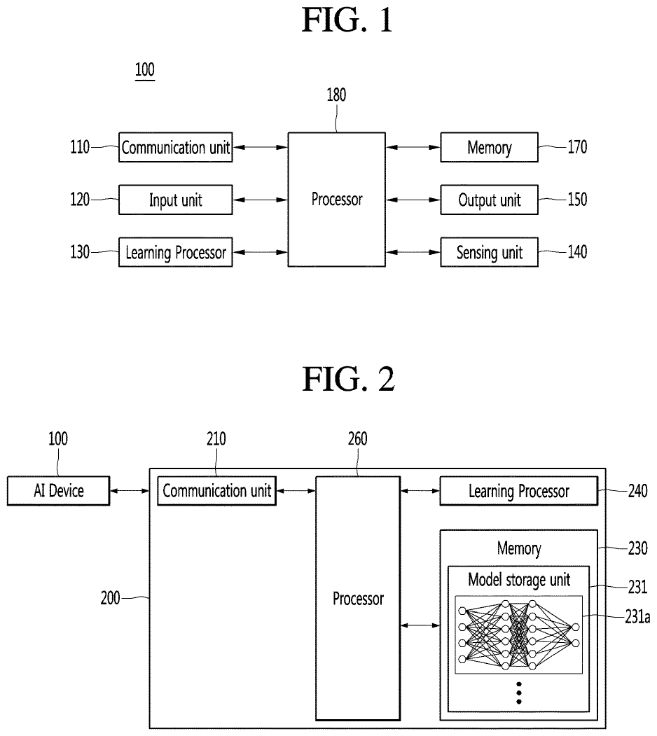

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

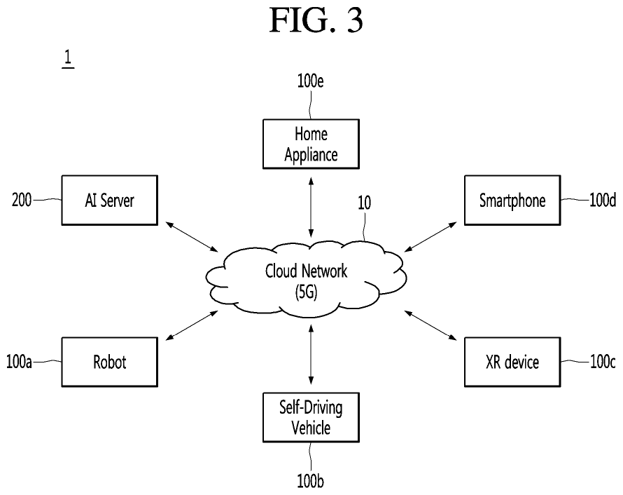

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement an AI model to generate output based on a plurality of modalities. Also, the generated output can be used by AI systems in various downstream related tasks other than text generate (e.g., object identification, control instructions to move a robot, control maneuvering for a self-driving vehicle, in game content generation, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input to determine a target task and produce a contextually grounded response, carry out a valid and logically progressive action within an environment, or output a sequence of executable actions to achieve task resolution.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data. According to embodiments, the AI model can be fully implemented on an edge device (e.g., locally on devices 100a to 100e) or fully implemented AI server 200 in which an edge device collected the raw audio and video signals to provide to the AI server 200. According to another embodiment, parts of the AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

In addition, the AI server 200 can learn the artificial neural network according to the machine learning algorithm instead of the AI devices 100a to 100e, and can directly store the learning model or transmit the AI model to the AI devices 100a to 100e.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart washing machine or dryer, smart refrigerator or other display device, which can implement an autonomous large language model (LLM) agent utilizing the neuro-symbolic framework, a digital avatar assistant, an online shopping assistant or concierge, or a complex task execution system, etc. The method can be in the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of map data, object information detected from the sensor information, environment observations, extracted target objects, or contextual relational priors acquired from a commonsense augmentation module to determine an execution trajectory and an action plan, and can control the autonomous agent such that the robot 100a executes the task along the determined trajectory. Further, the robot 100a can determine a valid and logically progressive action to pursue based on an aggregated augmented prompt, or generate a structured progress statement. Also, the robot 100a can generate an answer or reasoned action plan in response to a user query indicating a target task, and the robot 100a can have animated facial expressions. The answer or action plan can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Also, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's personal preferences.

According to an embodiment, the AI device 100 can provide a method for controlling the execution of complex tasks by autonomous large language model (LLM) agents by generating and leveraging an aggregated augmented prompt within a multi-component neuro-symbolic framework to produce valid and logically progressive actions grounded in the specific rules and context of a target environment.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, embodiments of the present disclosure relate to the field of artificial intelligence (AI) and machine learning, and more particularly, to methods and systems for controlling and grounding the behavior of autonomous large language model (LLM) agents to enhance their effectiveness and reliability in executing complex, sequential tasks within a defined environment.

For example, embodiments of the present disclosure can provide for a neuro-symbolic task execution framework for autonomous artificial intelligence agents, which can be viewed as a foundational component for applications requiring highly controlled and contextually grounded environmental interactions, such as household robotic assistants, automated web shopping agents, intelligent workflow automation systems, and complex physical or digital concierge services.

As discussed above, the operational capabilities of autonomous large language model (LLM) agents face several challenges that limit their practical utility and reliability in complex, real world environments. The agents have become proficient at generating natural language text and answering isolated queries, but their interaction with dynamic environments is often superficial. These agents need to be able to operate in real world scenarios by accurately inferring the surrounding environmental constraints and logically sequence multi-step actions without hallucinating invalid operations.

One challenge is the lack of a reliable mechanism to ground the agent's actions in the physical or digital realities of a specific domain. Related methods often operate on a strictly statistical or predictive language generation basis, without a deep understanding of domain-specific rules or spatial commonsense.

For example, a system might be tasked with navigating a household environment to retrieve an object. A conventional LLM agent may successfully generate a plausible sounding sequence of steps, but it will be unaware of basic physical constraints, such as the inability to walk through a solid wall or the necessity of opening a cabinet before grasping an item inside. This forces the system into execution errors or repetitive failure loops when attempting to carry out physically impossible tasks.

Another example of this limitation can be seen in complex digital tasks, such as automated web shopping or workflow execution. A system might be tasked with finding and purchasing a specific item online. A conventional model might correctly identify the initial search steps and open the correct webpage.

However, it would be incapable of accurately tracking its ongoing progress state, evaluating intermediate visual results, or dynamically adjusting its plan if a website layout changes or an item is out of stock.

The resulting generic action plan could cause the agent to repeatedly click invalid links, hallucinate successful transactions, or get stuck in a navigational loop, making it unsuitable for autonomous execution without substantial human oversight.

A further challenge in the existing art is the absence of a meaningful framework for enforcing logical consistency and environmental commonsense when attempting to plan and execute these sequential actions. They typically do not distinguish between an action sequence that is merely linguistically probable and one that is structurally valid and progressively moving toward task completion.

Accordingly, a need exists for improved systems and methods that can provide a multi-component neuro-symbolic framework for autonomous agents that has enhanced environmental grounding and state-tracking capabilities while ensuring logical consistency, and also reducing execution errors, hallucinated actions, and the need for constant human intervention.

According to an embodiment, the AI device 100 can provide a neuro-symbolic task execution framework that overcomes the limitations of prior approaches. For example, a multi-component framework can be employed that utilizes one or more artificial intelligence models, in which different components are configured to perform specialized tasks. The framework can include an environment constitution module to establish domain-specific rules and constraints, a commonsense augmentation module to provide spatial and relational priors, and a state tracking module to maintain the progressive execution status, thereby ensuring that the autonomous agent generates valid, logically consistent and contextually grounded actions.

An LLM-based framework can offer many advantages. For example, Large Language Models (LLMs) can be used to implement one or more components of the neuro-symbolic framework, such as the base Large Language Model (LLM) (neural part), or even the manager module, or the state tracking module. According to embodiments, even the environment constitution module and the commonsense augmentation module could be implemented as focused LLMs. However, embodiments are not limited thereto, and according to an embodiment, only the base Large Language Model (LLM) can be implemented as an LLM while the other modules can be implemented by symbolic programming logic, look-up tables or databases, etc.

These LLM model(s) can be configured to understand complex natural language instructions and generate coherent, logical sequences, which enables the framework to interpret nuanced environmental observations and provide detailed, contextually grounded executable actions and reasoned justifications for its planning trajectories.

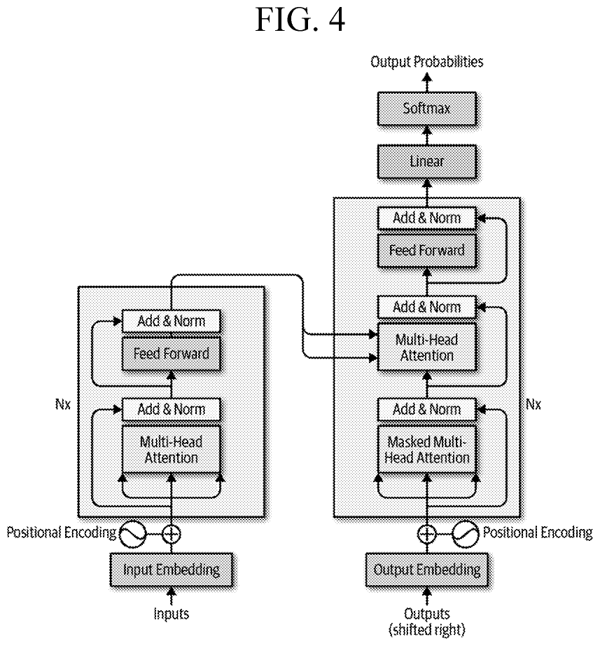

FIG. 4 illustrates an example encoder-decoder based transformer architecture for a large language model according to an embodiment of the present disclosure. For example, the method can leverage one or more large language models (LLMs). According to an embodiment, the LLM can be based on an encoder-decoder architecture, which employs self-attention mechanisms.

Further, these attention mechanisms can allow the model to weigh the importance of different parts of an input sequence (e.g., words in a task instruction, rules in an environment constitution, or previous steps in a state tracking history) when processing information to allow the model to capture long-range dependencies and contextual relationships effectively, which is particularly relevant for understanding complex sequential tasks or detailed environmental constraints.

According to an embodiment, the LLM can undergo its own pre-training phase, in which the LLM is trained on a massive and diverse amount of text and code. During this unsupervised or self-supervised learning stage, the model can learn fundamental language patterns, grammatical structures, factual knowledge, and even basic reasoning capabilities (e.g., predicting masked words or the logically progressive next sequence of text or actions). However, embodiments are not limited thereto. For example, according to an embodiment, only the base Large Language Model (LLM) (neural part) may undergo a pre-training phase.

According to an embodiment, the LLM portion can be subject to a fine-tuning phase. Fine-tuning can involve further training the pre-trained model on smaller, more specialized datasets tailored to specific tasks (e.g., domain-specific action generation, spatial reasoning, or specific environment rules) or to align the model's behavior with desired characteristics, such as improved instruction following, safety protocols, or strict adherence to neuro-symbolic constraints.

According to embodiments, the AI model can advantageously utilize pre-trained LLMs, potentially without requiring extensive task-specific fine-tuning for its core autonomous agent functionalities. For example, according to an embodiment, the AI model can be LLM agnostic, but embodiments are not limited thereto. According to an embodiment, only the base Large Language Model (LLM) (neural part) may undergo fine-tuning, but embodiments are not limited thereto.

For example, the LLM portion can operate by processing textual inputs (e.g., prompts, such as an aggregated augmented prompt) which can include target task queries, environmental constraints, progress histories, or other text intended to elicit a specific reasoned action. The LLM can leverage its learned knowledge to generate a corresponding textual output, such as a valid executable step, a structured progress update, or other contextually grounded content.

Also, according to an embodiment, the LLM portion can be multi-modal to accept and operate on other types of input, such as images (e.g., visual observations of a physical household or web shopping environment), video, etc.

In addition, one or more of the various components of the framework can be configured as artificial intelligence agents (e.g., AI agents). For example, an AI agent can be an autonomous computational system designed to process information and take actions to achieve specific goals. An agent can receive inputs, perform reasoning about those inputs based on its internal logic and knowledge, and produce outputs or executes tasks in response. According to embodiments, these agents can range from rule-based systems to highly complex models capable of sophisticated reasoning and decision-making.

According to an embodiment, the one or more AI agents can be based on Large Language Models (LLMs) that can be endowed with more sophisticated capabilities, such as planning, memory and the ability to use external tools.

For example, a planning module can allow the agent to decompose a high-level goal into a sequence of smaller, manageable steps. A memory module can provide the agent with the ability to retain information from past interactions, allowing it to maintain context and learn over time.

Further, the ability to use external tools can enable the agent to interact with other software, APIs or data sources to gather information or perform actions to execute a wide variety of complex, real-world tasks.

In addition, one or more of the various components of the framework, such as the manager module, the state tracking module, or the core large language model (LLM) itself, can be configured or extended as autonomous artificial intelligence (AI) agents. According to an embodiment, the entire framework can operate as one main autonomous agent.

For example, an AI agent can be an autonomous computational system designed to process a high-level query and generate a specific, contextually grounded reasoning output to achieve a solution within a defined physical or digital environment.

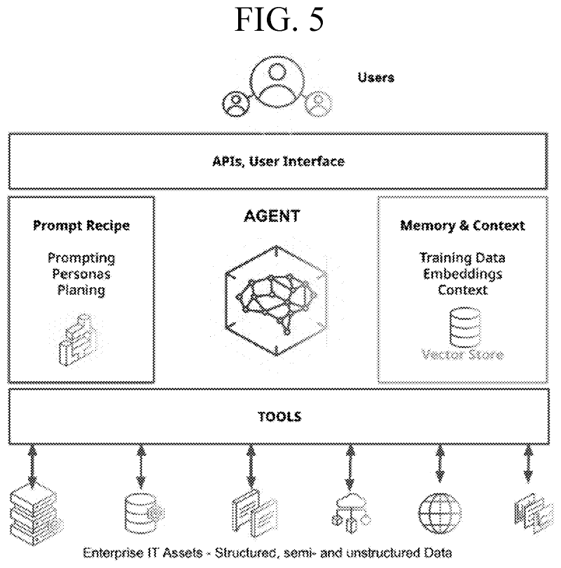

As illustrated in FIG. 5, which depicts a block diagram of an AI agent architecture configured to interact with enterprise tools and data, an agent can receive inputs, such as user instructions and environmental observations, perform reasoning about those inputs based on its internal parameters and neuro-symbolic constraints, and produce a structured action plan or execute specific environmental tasks in response.

According to embodiments, these agents can range from specialized, smaller models handling specific structural rules or commonsense priors to highly complex foundational models capable of sophisticated reasoning, decision making and tool orchestration.

According to an embodiment, the one or more AI agents can be based on LLMs that can be endowed with more sophisticated capabilities, such as chain-of-thought planning, environmental state and context retention, and the ability to autonomously use external tools or computer interfaces.

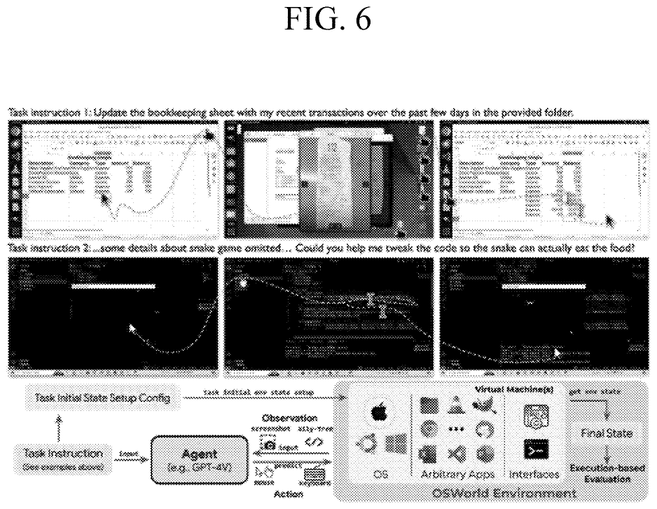

For example, turning to FIG. 6, which illustrates an example of an autonomous agent performing tasks on a computer, a planning or manager module can allow the agent to decompose a high-level query (e.g., organizing digital files, managing enterprise data, or navigating an operating system) into a sequence of smaller, manageable execution steps (e.g., a planned task trajectory) to achieve the overarching goal. A state tracking or memory module can provide the agent with the ability to retain information from previous actions and dynamic environmental updates, allowing it to maintain context across a long sequence of operations and learn to distinguish valid, logically progressive steps from invalid, prohibited, or hallucinated actions over time.

Further, the ability to use external tools can enable the agents to interact dynamically with other software, application programming interfaces (APIs), digital interfaces, or external data structures (e.g., enterprise knowledge bases, computational engines, or web environments) to gather verification data, parse visual screen states, or perform intermediate operations to execute a wide variety of complex, real-world tasks.

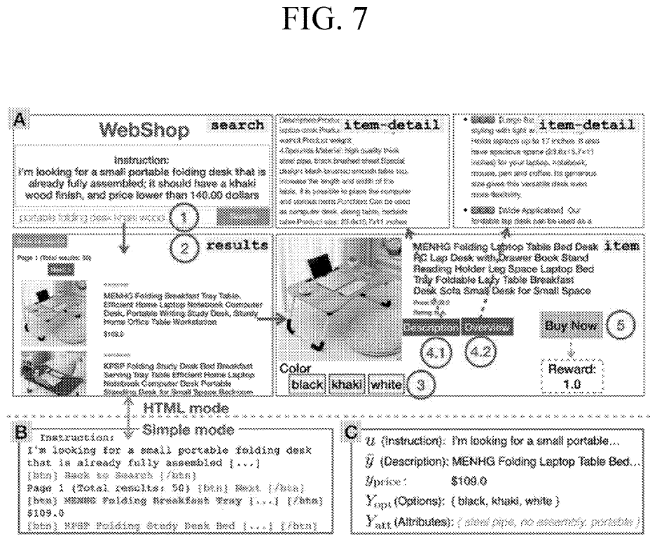

For example, as illustrated in FIG. 7, which depicts an example of an autonomous agent performing tasks in a web shopping environment, the agent can utilize external tools to navigate a web browser, evaluate product descriptions against user constraints, click interactive graphical elements, and autonomously complete a transaction sequence.

By grounding the LLM's reasoning within the specific neuro-symbolic rules of the web environment, the agent can effectively synthesize visual and textual data to execute the sequential shopping task autonomously, mitigating the risk of navigational loops or operational execution errors.

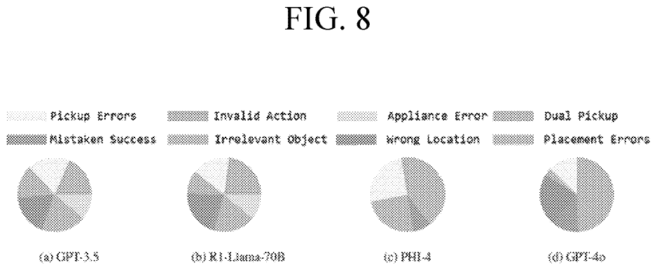

FIG. 8 illustrates an example comparison of error type distributions for different baseline large language models (LLMs) when attempting to execute sequential tasks in an environment, as comparative examples.

As shown in the visual representations for various baseline models (e.g., GPT-3.5, R1-Llama-70B, PHI-4, and GPT-40), conventional neural agents operating without neuro-symbolic grounding are highly susceptible to a wide variety of execution failures. These failures frequently include “Invalid Actions” (e.g., attempting an operation not supported by the system), “Wrong Location” or “Placement Errors” (e.g., failing to understand spatial geometry), and “Appliance Errors” or “Dual Pickup” violations (e.g., hallucinating the ability to hold multiple objects without a free hand or misusing a device).

This distribution of error types highlights the inherent limitations of relying solely on statistical language generation for autonomous task execution, which the present method regarding a prompt-driven neuro-symbolic agent is specifically designed to overcome, according to embodiments. Because purely neural LLMs lack an innate understanding of physics or domain-specific constraints, they easily fall into these documented failure situations.

The neuro-symbolic framework of the present disclosure can directly address and mitigate these specific failure modes. For example, by integrating an environment constitution module, the framework can enforce hard domain rules to actively block or prevent “Invalid Actions” and “Dual Pickup” errors before they are routed to the environment.

Similarly, the commonsense augmentation module can provide the spatial and relational priors to avoid or drastically reduce “Wrong Location,” “Pickup Errors,” and “Irrelevant Object” interactions. Thus, FIG. 8 demonstrates the baseline technical problem that the disclosed multi-component framework can resolve, ultimately transforming an otherwise error-prone LLM into a highly reliable and contextually grounded autonomous agent.

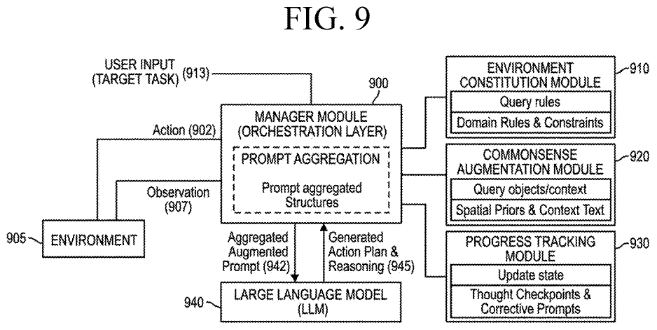

FIG. 9 illustrates a block diagram of an example framework for an autonomous agent, according to an embodiment of the present disclosure. For example, according to an embodiment, the AI model can be implemented as a cohesive architecture of interconnected modules designed to implement the multi-phase workflow previously described.

As shown in FIG. 9, the framework can include a manager module 900 acting as an orchestration layer, an environment constitution module 910, a commonsense augmentation module 920, a progress tracking module 930, and a large language model (LLM) 940, all configured to interact with a target environment 905.

According to an embodiment, all this entire framework can be implemented on or by the AI device 100. However, embodiments are not limited thereto and one or more components can be implemented by an external device or server that is in communication with the AI device 100.

For example, the framework can include two main operational loops, in which the first loop can be referred to as a contextual grounding pipeline where the manager module 900 interfaces with the environment constitution module 910, the commonsense augmentation module 920, and the progress tracking module 930, and the second loop includes the inference and execution phase utilizing the large language model (LLM) 940 to generate commands for the environment 905.

According to an embodiment, the framework can begin processing at the manager module 900, which can be configured as a central orchestrator or controller. The manager module 900 can receive a user input 913 (e.g., a target task instruction) and/or an initial observation 907 (e.g., a visual or textual state representation) from the environment 905 as inputs.

Internally, the manager module 900 can operate as a logic engine that analyzes the user input 913 and the observation 907 to determine the required context for the task. The manager module 900 can systematically query the ancillary modules to build a comprehensive state representation.

For example, the manager module 900 can query the environment constitution module 910 to obtain relevant rules and constraints, send query objects/context to the commonsense augmentation module 920, and send state updates to the progress tracking module 930.

Further in this example, following these initial queries, the environment constitution module 910 can receive an extracted domain from the user query as an input, to return relevant rules for that given domain or environment. According to an embodiment, the environment constitution module 910 can operate as a structured database or rules engine.

For example, the environment constitution module 910 can function to retrieve the strict operational boundaries specific to the current domain. Based on this retrieval, the environment constitution module 910 can output specific domain rules and constraints back to the manager module 900. According to an embodiment, the environment constitution module 910 can be implemented as a lookup table or SQL database.

Concurrently or sequentially, the commonsense augmentation module 920 can receive the query objects/entities/context as inputs. The commonsense augmentation module 920 can be configured as a lookup table, a relational knowledge graph or associative memory module.

Internally, the commonsense augmentation module 920 can map the specific entities found in the observation 907 to typical real-world relationships. As a result of this mapping process, the commonsense augmentation module 920 can output spatial priors and context text to the manager module 900.

Further still in this example, the progress tracking module 930 can receive the update state information from the manager module 900 as an input. The progress tracking module 930 can be configured as a persistent memory or a finite state machine.

According to an embodiment, the progress tracking module 930 can function to log the history of the current session and evaluate the sequential logic of the target task. The progress tracking module 930 can output structural thought checkpoints and corrective prompts to the manager module 900. The progress tracking module 930 can be implemented as heuristics or symbolic programming logic, according to embodiments.

After retrieving data from these ancillary modules, a prompt aggregation compiler within the manager module 900 can process the domain rules and constraints, the spatial priors and context text, and the thought checkpoints and corrective prompts as inputs.

The prompt aggregation compiler can format and combine these diverse data streams into prompt aggregated structures. Through this fusion process, the manager module 900 can generate and output a single, highly structured aggregated augmented prompt 942.

Next, the large language model (LLM) 940 can receive the aggregated augmented prompt 942 as an input. The LLM 940 can be configured as an AI-based deep learning module that utilizes a transformer neural network architecture.

Internally, the LLM 940 can apply self-attention mechanisms to evaluate the user's target task strictly within the confines of the provided domain rules, spatial priors, and progress history. As a result of this inference process, the LLM 940 can generate and output a generated action plan and reasoning 945 back to the manager module 900.

Then, the manager module 900 can receive the generated action plan and reasoning 945, parse the intended operational step, and output a final, validated action 902.

The action 902 can be transmitted directly or indirectly to the environment 905 to execute a physical movement (e.g., moving a robot arm, etc.) or digital interaction (e.g., completing an online purchase, etc.).

In response to the executed action 902, the environment 905 updates its state and generates a new observation 907, which is fed back into the manager module 900, thereby creating a continuous, contextually grounded execution loop until the target task 913 is successfully resolved. According to embodiments, the environment 905 can be a simulated environment or an actual real world environment.

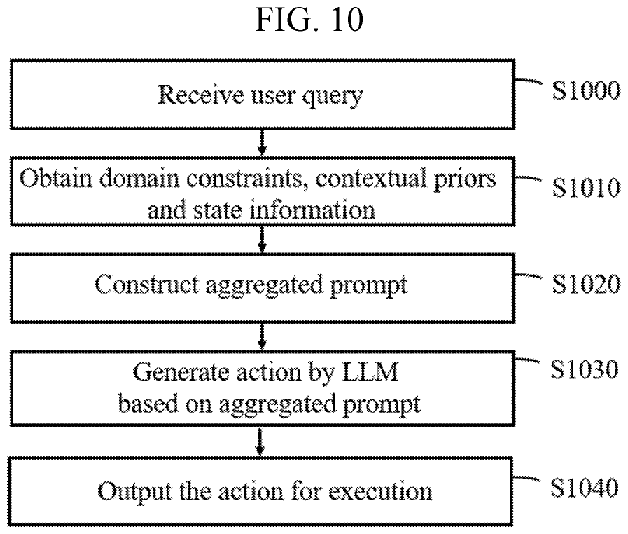

FIG. 10 shows an example flow chart of a method for controlling an artificial intelligence (AI) device 100, according to an embodiment of the present disclosure. For example, according to an embodiment, the method can be executed by a processor of the AI device 100 to implement the multi-module neuro-symbolic framework described above.

At step S1000, the method can include receiving, by a processor in the AI device 100, a user query indicating a target task and an observation from a target environment. For example, the user query can be a natural language instruction provided by a user, and the observation can be a text based state description or a visual representation of the current environment.

At step S1010, the method can include obtaining, by the processor, a set of domain constraints, a set of contextual priors, and state information based on the user query and the observation. According to an embodiment, this obtaining step can involve parsing the user query and the observation via a manager module to extract an operational domain and target entities, and then querying a plurality of independent symbolic modules.

For instance, the system can retrieve unalterable physical laws from an environment constitution module, statistically probable locations or functional affordances from a commonsense augmentation module, and a sequential log of prior actions and sub-goals from a progress tracking module configured as a finite state machine.

At step S1020, the method can include constructing an aggregated prompt sequence that fuses the user query and the observation with the set of domain constraints, the set of contextual priors, and the state information.

During this construction, the method can further inject a predefined list of permissible action templates and a plurality of few-shot examples. This strategically teaches the language model a structured reasoning format, mandating that the model alternates between generating an intermediate thought to validate a sub-goal and outputting a strictly formatted action.

Further in this example, at step S1030, the method can include generating, by a large language model, an action based on the aggregated prompt sequence. Because the prompt is heavily structured, the set of domain constraints and the set of contextual priors can effectively restrict the available action space of the large language model. This proactively prevents the execution of physically impossible or contextually invalid operations, significantly reducing execution failures and reasoning hallucinations.

At step S1040, the method can include outputting the action for execution within the target environment. Depending on the deployment, the target environment can be a real-world physical environment such as where the action is output as a motor control signal to a robotic apparatus, or a digital environment such as where the action is output as an automated web browser interaction.

Furthermore, following execution, the method can function as a continuous loop. For example, the method can iteratively receive an updated observation from the target environment, update the state information based on the executed action, obtain updated constraints and priors, construct an updated aggregated prompt sequence, and generate a subsequent action until the target task is fully resolved.

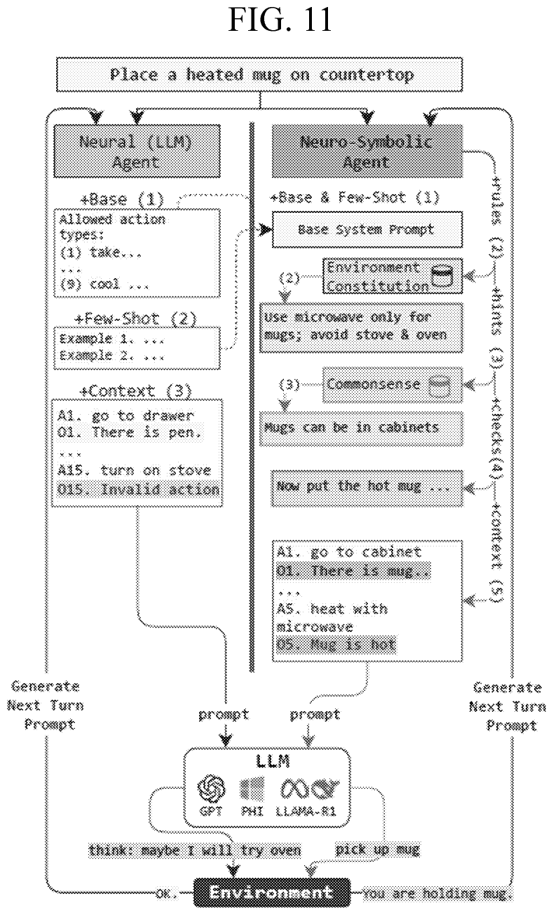

FIG. 11 illustrates an overview of a pipeline architecture comparing a baseline neural agent to a neuro-symbolic agent framework, according to an embodiment of the present disclosure. To understand advantages of the multi-component architecture, the left side of FIG. 11 depicts the operational flow of a related art baseline neural agent as a comparative example, while the right side details the highly structured, contextually grounded processing pipeline of the neuro-symbolic framework according to an embodiment of the present disclosure.

Referring first to the baseline neural agent on the left side of FIG. 11, a related art artificial intelligence (AI) system typically employs a direct, unconstrained inference path. In this baseline approach, the agent receives an unstructured target task from the user, a one or few shot example, and a raw observation from the environment (e.g., a visual snapshot of a room or the HTML text of a webpage). In other words, it has a basic three part system prompt.

Further in this example, the baseline neural agent passes these inputs directly into a large language model (LLM) without any intermediate filtering or structural augmentation. The LLM relies solely on its pre-trained statistical weights to guess the most likely next word or action.

Because the related art model lacks a formalized understanding of physical boundaries or domain-specific rules, the generated output frequently results in invalid actions. For instance, the baseline agent might hallucinate a button that does not exist on a webpage or attempt a physical movement that violates the laws of physics, a wasteful or nonsensical action given the current task and context (e.g., opening an oven to try and find a pen), which causes the task to fail or enter a repetitive error loop.

To mitigate or prevent these hardware and computational inefficiencies caused by execution failures, the neuro-symbolic agent framework detailed on the right side of FIG. 11 according to an embodiment can advantageously leverage a multi-module orchestration pipeline. Rather than relying on an unconstrained LLM, the framework introduces a manager module that can systematically build a logically constrained context before any neural inference occurs.

According to an embodiment, this controlled context generation can be achieved through the integration of three distinct symbolic components that can include an environment constitution module, a commonsense augmentation module, and a progress tracking module. However, embodiments are not limited thereto, and only one or two of the three symbolic components can be used according to embodiments and design considerations.

By forcing the LLM to operate strictly within the boundaries defined by these modules, the framework can better guarantee that all generated actions are valid, grounded and progressively moving toward the target goal.

For example, the process flow can begin when the manager module receives a user query (e.g., find a mug and heat it). Before invoking the LLM, the manager module can query the environment constitution module. The environment constitution module can act as a strict rules engine that defines the unalterable laws of the current domain.

For example, if the neural-symbolic agent is operating in a digital web shopping environment, the environment constitution module can retrieve a specific set of hard rules for that digital web shopping environment, such as prohibiting the selection of a checkout button before an item has been added to the digital cart.

The environment constitution module can output these domain constraints to the manager module, thereby pruning the available action space of invalid operations.

Concurrently or sequentially, the manager module can query the commonsense augmentation module and pass it information regarding identified entities or objects within the user query.

The commonsense augmentation module can be configured to inject real world spatial and relational priors into the pipeline to prevent the agent from making contextually absurd decisions. According to an embodiment, the commonsense augmentation module can be implemented as a lookup table, a database call, or a knowledge graph that maps the entities found in the observation to expected real-world relationships.

For example, in a physical real world scenario, a user might instruct an autonomous robotic agent to navigate a kitchen environment to heat a mug of liquid. The commonsense augmentation module can provide the relational prior that heating a mug typically requires a specific appliance, such as a microwave (e.g., rather than a stove or oven), and establishes the physical prerequisite that the microwave door must be opened before the mug can be placed inside.

According to another example, For example, a user might instruct an autonomous robotic agent to navigate a kitchen environment to retrieve a carton of milk. The commonsense augmentation module can provide the spatial prior that milk requires refrigeration and is highly likely to be located inside a refrigerator, rather than inside an oven or a dry pantry.

By outputting these semantic priors, the commonsense augmentation module can ensure the agent logically navigates to the refrigerator first, rather than blindly searching every cabinet in the room.

Further in this example, the manager module can also interface with the progress tracking module, which can function as a persistent finite state machine and session memory, according to an embodiment. The progress tracking module can maintain a strict sequential log of all prior actions, intermediate thought checkpoints, and current sub-goals.

However, embodiments are not limited thereto. For example, according to another embodiment, the progress tracking module can be implemented as a separate LLM-based agent instructed with its own set of specialized prompts.

In a complex digital task, such as an agent booking a multi-city flight itinerary, the progress tracking module can ensure that the agent recognizes its current operational state. It allows the system to know whether it has successfully completed the “departure date selection” phase and is now in the “seat selection” phase. The progress tracking module can output this state information to the manager module, providing a structural checkpoint that grounds the agent in the temporal reality of the task and completely prevents it from endlessly looping back to steps that have already been completed.

Once the manager module has collected the data from these three symbolic programming modules, it can utilize an aggregation process to construct a unified and highly constrained prompt.

For example, the manager module can effectively fuse the raw user query, some few-shot examples, and the current environmental observation with the strict rules from the environment constitution module, the spatial priors from the commonsense augmentation module, and the temporal state from the progress tracking module.

Through this deterministic fusion process, the manager module can create an aggregated augmented prompt. By combining the target task with these strict symbolic guardrails, the resulting prompt provides a complete, foolproof boundary for the neural network that leaves no room for ungrounded hallucination and prevents wasteful steps.

Then, this aggregated augmented prompt is fed into the large language model (LLM). Because the prompt is heavily structured by the symbolic framework, the LLM's self-attention mechanisms can be forced or focused to evaluate only the valid, logically progressive pathways. The LLM processes the prompt to determine the most contextually appropriate action that strictly complies with the provided boundaries.

In this way, by ensuring that the LLM only selects from a pool of available actions that have been pre-screened for physical possibility and domain compliance, the neuro-symbolic agent framework can ensure an exceptionally high success rate for complex tasks with a smaller number to steps.

This validated, optimal action can then be routed back through the manager module and executed within the target environment (e.g., real, simulated, or digital). The execution of this action can trigger a new observation from the environment and advances the progress tracking state machine to its next phase, thereby seamlessly continuing the autonomous execution loop until the overarching task is completely resolved.

To further explain the technical advantages of the architecture detailed in FIG. 11, the manager module can be understood not merely as a pass-through node, but as a complex orchestration engine that can include a plurality of internal sub-functions.

According to an embodiment, the manager module can be logically broken down into several specific internal sub-components, which can include a domain parsing and entity extraction engine, a symbolic query router, a state management interface, a prompt aggregation compiler, and an application programming interface (API) and execution router.

For example, the domain parsing and entity extraction engine can be configured to act as the initial processing layer for any incoming unstructured data, such as the user query or the raw environmental observation. This engine can utilize natural language processing (NLP) techniques, such as named entity recognition (NER), to identify and isolate critical contextual anchors within the text.

For example, if a user issues a command to “navigate to the kitchen and find an apple,” the extraction engine can parse this string to identify “kitchen” as the target domain or operational zone, and “apple” as the target object entity.

According to alternative embodiments, this engine can be implemented using a lightweight, locally hosted language model for rapid, secure entity tagging, or it can utilize deterministic regular expression (regex) algorithms if operating in a highly constrained, predefined environment, according to design considerations.

Further, once the key entities and domain parameters are extracted, the manager module can utilize the symbolic query router to retrieve the relevant constraints and priors. The symbolic query router can be configured to format the extracted entities into specific query languages or data structures compatible with the environment constitution module and the commonsense augmentation module.

For example, the query router can generate a graph database query (e.g., a SPARQL or Cypher query) to retrieve the location priors for the entity “apple” from a semantic knowledge graph, or it could execute a vector similarity search to pull relevant domain rules for a “kitchen” environment. This sub-function can ensure that the retrieval of symbolic rules is highly targeted and computationally efficient.

In addition, the manager module can include a state management interface, which can serve as a type of temporal memory controller for the framework. The state management interface can be configured to continuously log all generated actions, environmental observations, and intermediate thought processes.

The state management interface can package this logged data and transmit it to the progress tracking module to update the overall state machine.

In alternative embodiments, particularly for enterprise level or secure autonomous agents, the state management interface can maintain these logs in a secure format, such as a localized distributed ledger or a cryptographically signed JSON file, ensuring that the agent's decision making history is fully auditable and resistant to tampering.

In addition, after the relevant rules, spatial priors and state checkpoints are retrieved from the respective modules, the prompt aggregation compiler can synthesize these diverse data streams.

For example, the prompt aggregation compiler can act as a type of formatting engine that logically orders the constraints, the few-shot behavioral templates, the operational syntax rules, and the current observation into a single, cohesive text block (e.g., the aggregated augmented prompt).

According to alternative embodiments, the prompt aggregation compiler can dynamically select from a plurality of different prompt templates based on the domain parsed in the first step. For instance, it can compile a specific prompt structure optimized for web-browser DOM manipulation if a digital shopping task is detected, or compile a different structure optimized for physical spatial reasoning if a household robotic task is detected.

Then, the manager module can employ the API and execution router to manage the bidirectional communication between the neural network and the physical or digital environment.

For example, on the input side, this router can handle the network protocols to securely transmit the aggregated augmented prompt to the core large language model (LLM) and receive the generated text response.

Also, on the output side, the API and execution router can parse the LLM's selected action and translate the natural language command into specific, machine executable instructions.

For a physical embodiment example, this can involve translating a command like “go to fridge 1” into motor control signals via a robot operating system (ROS) middleware.

Alternatively, for a digital embodiment, the API and execution router can translate a “click checkout” command into automated web browser interactions using various tools. This can ensure that the AI's reasoning is seamlessly converted into tangible results in the real world or simulated environments.

According to an alternative embodiment, the manager module itself can be implemented as a specialized artificial intelligence agent or a meta-system utilizing its own dedicated large language model (LLM). In this multi-agent configuration, rather than relying solely on deterministic programming logic or rigid routing scripts to coordinate the sub-modules, the manager module can act as an intelligent, natural-language orchestrator.

For example, this orchestrating meta-LLM can be configured with advanced function calling or tool use capabilities to allowing it to dynamically evaluate the semantic nuance of an unstructured user query and autonomously determine which specific symbolic databases or modules should be accessed.

Further in this example, instead of executing a hardcoded retrieval sequence, the meta-LLM can dynamically write queries to the environment constitution module to fetch specific rules, prompt the commonsense augmentation module to fill in missing spatial priors, and converse with the progress tracking module to understand the current temporal state.

Furthermore, this meta-LLM can intelligently synthesize, filter and summarize these retrieved constraints to generate a highly optimized and dynamically formatted aggregated augmented prompt. This alternative configuration can provide improved flexibility and reasoning capabilities for handling highly irregular or ambiguous edge case scenarios before passing the finalized instructions to the primary execution LLM.

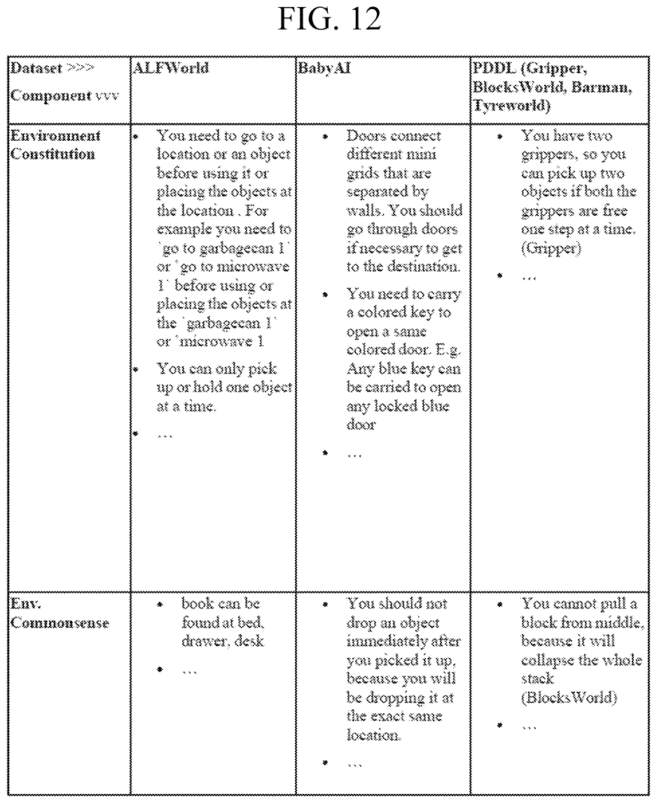

FIG. 12 illustrates an example table comparing domain-specific rules and spatial priors across different target environments or datasets, according to embodiments of the present disclosure.

As shown in FIG. 12, the table categorizes these parameters into “Environment Constitution” rules and “Env. Commonsense” (e.g., Commonsense Augmentation) priors for three distinct operational domains that include an ALFWorld household environment, a BabyAI grid-world navigation environment, and a PDDL planning environment (e.g., Gripper, BlocksWorld).

By classifying and storing these rules, the respective modules within the neuro-symbolic framework can dynamically inject the correct constraints into the large language model (LLM) based on the specific domain the autonomous agent is currently operating within.

For example, the “Environment Constitution” row details the hard physical or systemic laws that the agent cannot violate without causing an execution error. In the ALFWorld domain, the constitution enforces rules such as requiring the agent to physically navigate to a location (e.g., “go to garbagecan 1”) before interacting with it, and strictly limiting the agent to holding only one object at a time.

Similarly, in the BabyAI domain, the environment constitution defines systemic rules, such as requiring a specific colored key to open a matching locked door. In a PDDL Gripper scenario, the environment constitution explicitly defines hardware limitations, dictating that the agent has exactly two grippers and can thus manipulate a maximum of two objects simultaneously.

By outputting these rules, the environment constitution module can effectively prune physically impossible actions from the agent's available action space.

In addition, the “Env. Commonsense” row illustrates the heuristic logic, spatial probabilities, and physical priors that can be provided by the commonsense augmentation module.

For example, rather than hard systemic boundaries, these can represent real-world reasoning that prevents the agent from making contextually absurd decisions. For instance, in the ALFWorld domain, the commonsense prior informs the agent that a book is statistically likely to be found at a bed, drawer, or desk, thereby guiding its search strategy.

In the BabyAI domain, a commonsense rule prevents redundant loops by instructing the agent not to drop an object immediately after picking it up in the exact same location.

Further, in a PDDL BlocksWorld scenario, the commonsense prior injects a basic understanding of physics, warning the agent that pulling a block from the middle of a stack will cause the entire structure to collapse.

By fusing these distinct constitutional constraints and commonsense priors into the aggregated prompt, the framework can ensure that the generated action trajectories are both technically valid and logically sound.

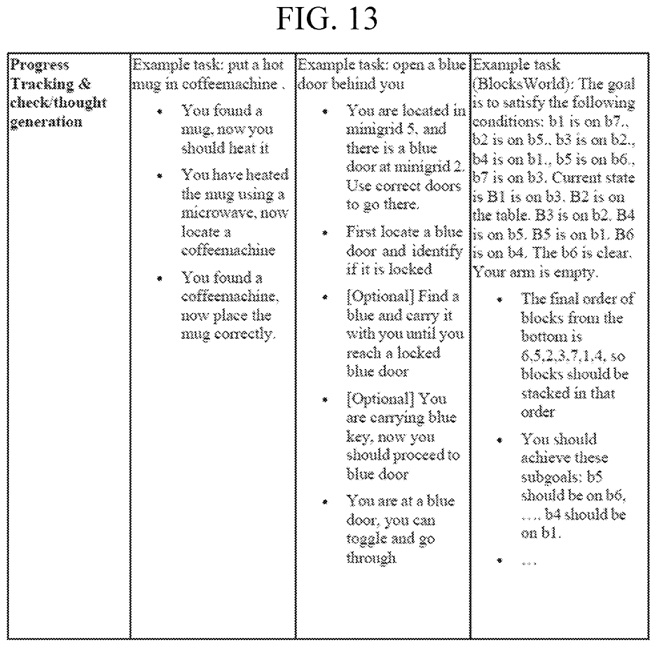

FIG. 13 illustrates an example table of progress tracking and thought generation outputs across different task domains, according to an embodiment of the present disclosure.

As shown in FIG. 13, the progress tracking module can be configured to decompose complex, multi-step tasks into a sequence of actionable sub-goals and intermediate state checkpoints.

By providing these structured “thoughts” or progress updates to the manager module, the framework ensures that the autonomous agent maintains temporal context and understands exactly where it is within the overall execution pipeline. This persistent state awareness is critical for preventing the agent from prematurely skipping required steps or indefinitely repeating actions it has already completed.

According to embodiments, the thoughts or progress updates can be programmatically implemented as a series of heuristics or structured if/then statements, or a coded finite state machine, etc., but embodiments are not limited thereto. For example, according to another embodiment, the progress tracking module can be implemented as a focused LLM with its own strict prompting.

Further in this example, the table in FIG. 13 demonstrates this dynamic state-tracking capability across three distinct environments. In a household scenario tasked with putting a hot mug in a coffee machine, the progress tracking module can track the sequential physical states, such as acknowledging when the mug is found, confirming when it has been heated using a microwave, and directing the agent to locate the coffee machine for final placement.

Also, in a grid-based navigation environment tasked with opening a blue door, the progress tracker can generate spatial and inventory based thoughts, such as noting the current minigrid location, identifying if the target door is locked, and generating optional sub-goals to find and carry a specific blue key before proceeding.

Further, in a logical planning scenario like BlocksWorld, the progress tracking module can evaluate the current state of stacked blocks against the complex goal conditions, outputting a highly specific, mathematically ordered list of required sub-goals (e.g., “b5 should be on b6”) to systematically guide the agent to the correct final configuration.

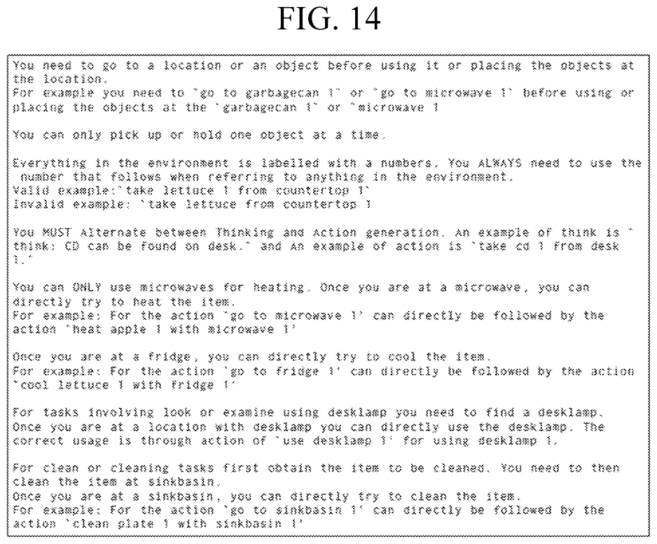

To assist in understanding a practical implementation of the neuro-symbolic agent framework, FIGS. 14 through 18 illustrate a complete, end-to-end operational sequence, according to a non-limiting example embodiment. This sequence can be conceptually divided into three distinct phases that can include foundational input generation, prompt aggregation, and environmental execution. By breaking down the workflow into these phases, the framework's ability to completely ground a large language model (LLM) before it generates an action becomes highly apparent.

For example, the first phase can involve establishing three foundational pillars that serve as the contextual inputs for the framework. As will be described in greater detail below, FIG. 14 illustrates an example regarding the environment constitution, which can define the absolute baseline of hard, unbreakable physical laws and rules of a given domain.

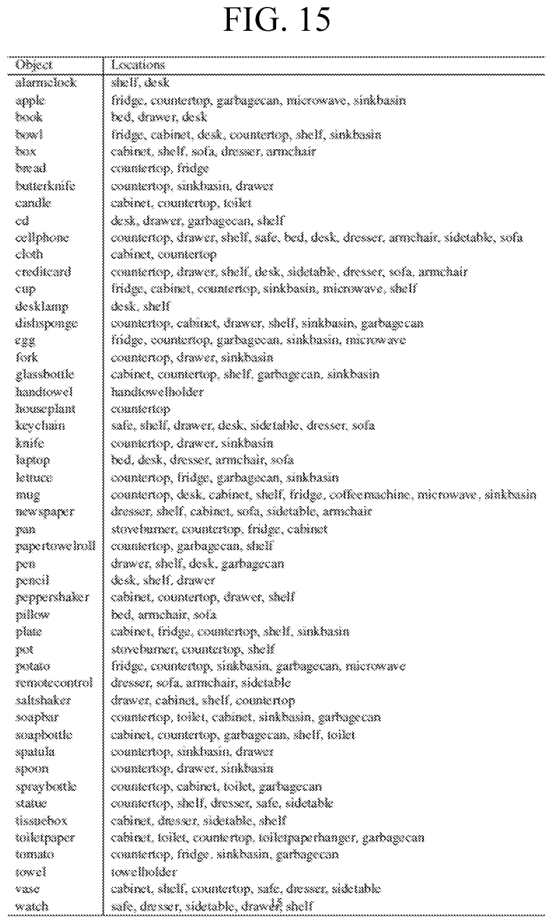

Building upon this, FIG. 15 introduces the commonsense augmentation, which can provide the heuristic logic and spatial priors (e.g., mapping objects to expected locations) that endow the agent with real world reasoning or “street smarts.”

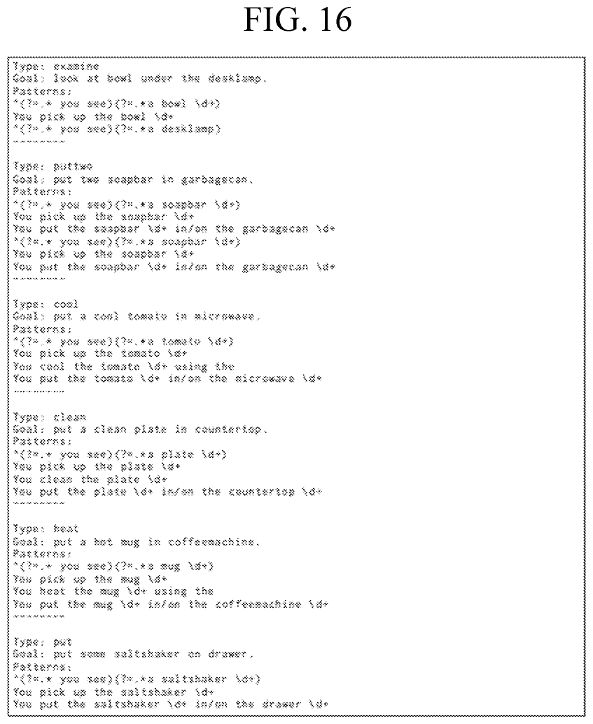

Then, FIG. 16 details an example regarding the progress tracking module, which can inject temporal awareness by tracking the agent's current state and sub-goals to prevent it from losing its place in a sequential task.

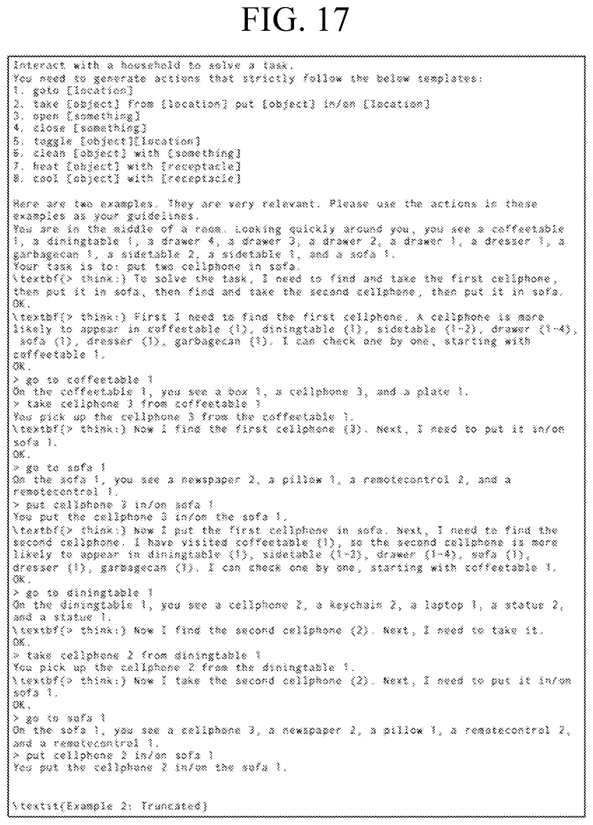

Following the generation of these three distinct data sources, the second phase can involve the processing and aggregation of the inputs. FIG. 17 illustrates how these foundational pillars can be synthesized and formatted into a structured prompt. This aggregation phase can utilize action templates and few-shot prompting to teach the LLM exactly how to interpret the rules and format its responses, which can effectively translate the constraints into a strict operational syntax.

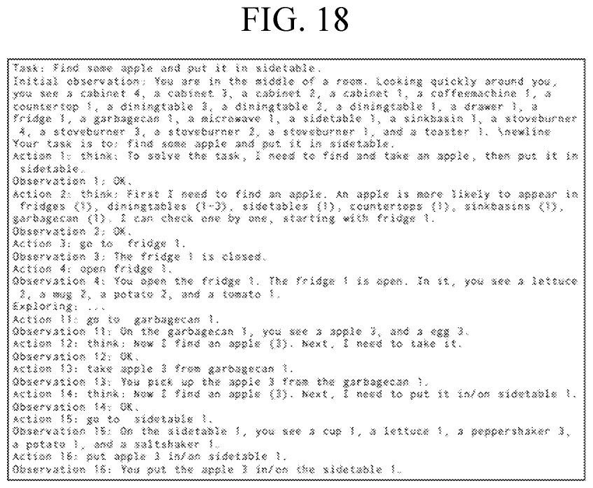

Then, the third phase demonstrates the output and result of this highly constrained processing pipeline. For example, FIG. 18 concludes the sequence by providing a proof of concept through a live execution trajectory. After the rules are defined (e.g., FIGS. 14-16) and the prompt is formatted (e.g., FIG. 17), FIG. 18 shows the successful back and forth execution of the autonomous agent operating within the target environment, fully grounded by the neuro-symbolic architecture, according to an embodiment.

FIG. 14 illustrates an example of a system prompt containing domain-specific rules and behavioral instructions, according to an embodiment of the present disclosure. In this example, the text translates the hard constraints of a target environment into natural language directives that a large language model (LLM) can directly process. Rather than allowing the model to freely guess how to interact with an environment, the prompt establishes clear, upfront operational boundaries.

For instance, the prompt explicitly defines physical limitations, such as restricting the agent to holding only one object at a time. It also dictates specific formatting and syntax rules to ensure the model's outputs are compatible with the underlying system's action space.

Further, the prompt mandates a structured reasoning format that instructs the model to alternate between generating intermediate thoughts and outputting executable actions.

By embedding these foundational rules directly into the prompt, the framework helps ensure that the agent's generated actions remain procedurally valid and logically grounded.

In other words, FIG. 14 shows example aspects of how the environment constitution can augment a prompt. It is the set of hard, underlying laws that the LLM is told it must obey before it even starts a task. It dictates the physics of the simulation or action space (e.g., “You can only pick up or hold one object at a time”) and the required logic (e.g., “You MUST Alternate between Thinking and Action”).

FIG. 15 illustrates an example table of spatial commonsense priors mapping objects to expected locations (e.g., objects, and their likely locations), according to an embodiment of the present disclosure.

As shown in FIG. 15, this data structure can serve as a foundational knowledge base for the commonsense augmentation module. It can provide a structured, relational mapping of specific items to their statistically probable or logically coherent receptacles or locations within a target environment (e.g., a household or physical room).

By utilizing this mapping, the framework can inject real-world heuristics into the aggregated prompt, effectively giving the artificial intelligence (AI) agent “street smarts” or “common sense” knowledge and preventing it from executing absurd or highly inefficient search strategies.

For example, referring to the entries in FIG. 15, if the autonomous agent receives a target task to retrieve an “apple,” the commonsense augmentation module query this table and output the prior that an apple is logically found in a “fridge,” “countertop,” “garbagecan,” “microwave,” or “sinkbasin.”

For instance, it can explicitly exclude illogical locations, meaning that the agent will not waste computational resources or execution steps attempting to open a “safe” or look under a “bed” for the food item. Similarly, the table maps a “book” to a “bed,” “drawer,” or “desk,” and maps a “soapbottle” to a “cabinet,” “countertop,” “garbagecan,” “shelf,” or “toilet.”

By providing these structured object-location pairs to the manager module, the framework can artificially narrow the large language model's (LLM) action space to only the most contextually grounded pathways, which can dramatically reduce the time and steps used to resolve complex navigation and retrieval tasks.

FIG. 16 illustrates an example of pattern matching templates that can be utilized by the progress tracking module to monitor and verify sequential task execution, according to an embodiment of the present disclosure.

As shown in FIG. 16, the progress tracking module can employ structured text patterns, including regular expressions (regex) and expected action sequences, to parse the textual observations returned by the environment.

For example, rather than relying on the large language model (LLM) to organically remember its past actions, the progress tracking module can actively compare the ongoing interaction log against these predefined templates. Once a specific pattern is matched in the environment's feedback (e.g., such as confirming the agent has successfully observed and picked up an object), the module can register that sub-goal as complete and update the overarching temporal state.

For example, referring to the entries in FIG. 16, different task types can have unique sequential milestones. For a “puttwo” task (e.g., putting two soapbars in a garbage can), the pattern template can have the system observe the agent finding the first soapbar, picking it up, placing it in the receptacle, and then successfully repeating the entire observation loop for a second soapbar before marking the task complete.

Similarly, for a “heat” task (e.g., putting a hot mug in a coffee machine), the patterns can dictate that the agent systematically match text confirming it saw the mug, picked it up, executed a heating action, and finally placed it in the coffee machine.

By utilizing these explicit verification patterns, the progress tracking module can output accurate, real-time state checkpoints to the manager module, which can prevent the autonomous agent from skipping important intermediate steps or hallucinating task completion.

FIG. 17 illustrates an example of a synthesized prompt featuring strict action templates and few-shot examples, according to an embodiment of the present disclosure.

As shown in the top portion of FIG. 17, the manager module can provide the large language model (LLM) with a definitive list of permissible syntactic templates (e.g., “goto [location]” or “take [object] from [location]”).

By explicitly defining this constrained syntax, the framework can bridge the gap between natural language reasoning and the specific programmatic application programming interface (API) or action space of the target environment. This can help ensure that when the LLM decides to move or interact, it formats its command in a way that the environment can perfectly parse and execute, thus eliminating errors caused by malformed or ambiguous text outputs.

Further in this example, the bottom portion of FIG. 17 demonstrates the use of few-shot prompting to teach the LLM the desired operational behavior through in-context learning. The prompt includes pre-written, highly relevant examples of a task being successfully solved, complete with alternating “think” and “action” steps.

By providing a perfect play-by-play transcript of a hypothetical execution (e.g., observing the room, thinking about the logical first step, and executing a “go to” command), the prompt serves as a behavioral tutorial.

In this way, the prompt can allow the LLM to mimic the precise reasoning and structural formatting for the neuro-symbolic framework, which can drastically improve its ability to autonomously navigate complex, multi-step tasks without needing extensive task-specific fine-tuning.

FIG. 18 illustrates an example execution trajectory of the AI device 100 implementing the neuro-symbolic agent framework to actively solve a task within a target environment, according to an embodiment of the present disclosure.

As shown in FIG. 18, the execution log can act as a real-time transcript demonstrating the successful integration of the previously described constitutional rules, commonsense priors, and structural formatting. The sequence highlights the agent's ability to autonomously process an initial observation, maintain temporal context, and continuously alternate between internal reasoning (e.g., think actions) and physical execution.

For example, the execution trajectory can begin with the assigned task to “Find some apple and put it in sidetable.” Rather than resorting to a random or unguided search, the agent immediately leverages the spatial priors provided by the commonsense augmentation module.

In Action 2, the agent generates a thought: “An apple is more likely to appear in fridges (1) . . . garbagecan (1),” which directly mirrors the heuristic logic established by the framework's knowledge base.

Then, the agent systematically executes targeted navigation commands, such as “go to fridge 1.” When the environment returns Observation 3 indicating that “The fridge 1 is closed,” the agent demonstrates state aware problem solving by dynamically adapting its plan and correctly issuing the prerequisite command to “open fridge 1” in Action 4.

Further in this example, the transcript demonstrates the method's strict adherence to the defined syntax and progress tracking templates. After systematically exploring, the agent navigates to the garbage can (Action 11) and receives an observation confirming the presence of “apple 3”.

Following the rulebook structure, the agent then generates a thought checkpoint via the progress tracking module to confirm the sub-goal (Action 12) before executing the exact allowable syntax “take apple 3 from garbagecan 1” (Action 13).

Then, the agent navigates to the target receptacle and successfully completes the multi-step task by executing “put apple 3 in/on sidetable 1” (Action 16). This end to end trajectory validates that the multi-component neuro-symbolic architecture effectively grounds the large language model, enabling it to execute highly complex, sequential environmental tasks without succumbing to hallucination, logical failure loops or unduly wasteful iterations.

Various experiments were carried out against related art models and the prompt-driven neuro-symbolic agent according to an embodiment to evaluate the results.

As shown in Table I below, the prompt-driven neuro-symbolic agent model according to embodiments outperforms other related-art methods.

TABLE I

| | GPT-3.5 | Llama-70B | PHI-4 | GPT-4 | GPT-4o |
|---|---|---|---|---|---|
| AgentBoard* | 17.2 | (v3) 12.7 | — | 43.3 | — |
| AgentBench* | 16.0 | (v2) 2.0 | — | 78.0 | — |
| Reflexion | — | — | — | 87.3* | 63.4 |
| ReAct | 53.7 | (R1) 32.8 | 64.9 | 82.1 | 79.1 |
| Ours | 71.6 | (R1) 62.7 | 95.5 | 97.0 | 100 |

For example, Table I compares task completion success rates of various artificial intelligence (AI) agent frameworks across different large language models (LLMs). As shown in Table I, the neuro-symbolic agent framework according to an embodiment of the present disclosure is evaluated against related art baseline methodologies in a simulated target environment.

A significant technical advantage demonstrated by this evaluation is the model-agnostic capability of the disclosed framework to elevate operational efficiency. The data indicates that the multi-module orchestration pipeline consistently yields superior success rates compared to related art approaches, regardless of the underlying foundational neural network being utilized. This allows systems with lower computational overhead or older generation models to achieve substantially higher success rates by relying on the framework's external symbolic logic constraints rather than internal neural inference alone.

Further, the evaluation demonstrates that the framework achieves improved reliability when paired with highly advanced LLMs, reaching near-perfect or absolute execution success rates. By strictly pruning invalid action spaces via the environment constitution and injecting explicit temporal state tracking, the disclosed method effectively eliminates the persistent hallucination, invalid formatting, and logical looping errors that traditionally cause autonomous AI agents to fail.

For example, as illustrated in the evaluation data, the disclosed framework achieves significantly higher success rates across all tested models when compared to related art methods. When applied to a baseline GPT-3.5 model, the framework improved task completion to 71.6%. Further, the framework enabled open weight models like PHI-4 to reach an exceptional 95.5% success rate, while pushing advanced models like GPT-40 to a flawless 100% completion rate. These higher scores empirically demonstrate the robust, model-agnostic improvements provided by the present invention.

As shown in Table II below, the prompt-driven neuro-symbolic agent model according to embodiments outperforms other related-art methods.

TABLE II

| | BabyAI | PDDL |
|---|---|---|
| ReAct | (56.2, 35) | (61.7, 30) |
| (SR, Avg. Number of Turns) | | |
| Ours | (90.17, 16.) | (85.0, 26) |
| (SR, Avg. Number of Turns) | | |

For example, Table II compares the performance metrics of the disclosed neuro-symbolic agent framework according to an embodiment of the present disclosure against a related art baseline approach (ReAct) across different target environments. As shown in Table II, the evaluation measures both the success rate (SR) and the average number of turns (e.g., execution steps) required to complete complex tasks in the BabyAI and PDDL environments. The data clearly demonstrates that the disclosed framework achieves a significantly higher overall success rate, but also reaches task completion in far fewer steps.

For instance, an advantage highlighted by these results is the dramatic reduction in wasteful computational overhead and exploratory errors. In the BabyAI grid environment, the disclosed framework achieves a 90.17% success rate using an average of only 16 turns, vastly outperforming the baseline ReAct approach, which manages only a 56.2% success rate while requiring an average of 35 turns.

Similarly, in the PDDL planning environment, the framework increases the success rate to 85.0% while simultaneously reducing the average number of turns to 26. By proactively grounding the language model with explicit environmental constitutions and commonsense priors, the framework effectively prevents the agent from engaging in invalid actions or repetitive error loops, resulting in a highly efficient and computationally economical path to task resolution.

According to an embodiment, the AI device 100 can be configured to achieve highly grounded and procedurally valid autonomous task execution by constraining neural inference with explicit symbolic rules. The AI device 100 can be used in various types of complex digital, simulated or physical environments to efficiently resolve multi-step tasks while preventing computational waste and execution failures.

According to one or more embodiments of the present disclosure, the AI device 100 can solve one or more technological problems in the existing technology, such as implementing accurate and grounded autonomous task execution through a multi-module neuro-symbolic framework that can provide enhanced procedural validity, logical reasoning and temporal state awareness, while also reducing wasteful computational overhead and execution failure rates.

For example, embodiments of the present disclosure can address the deficiencies of the related art baseline neural agent techniques, which suffer from an inability to accurately resolve physical boundaries or domain specific rules due to unconstrained neural inference, high execution error rates, persistent hallucination of invalid actions, and the computational waste associated with endlessly looping through illogical steps or skipping required sequential milestones.

For example, embodiments of the present disclosure can also address the deficiencies of the related art autonomous execution models, which suffer from a lack of temporal context, an inability to naturally sequence multi-step physical or digital interactions, and an over-reliance on internal pre-trained statistical weights rather than explicit, verifiable rules, which ultimately leads to contextually absurd decision making.

Furthermore, according to an embodiment, the AI device 100 configured with the disclosed neuro-symbolic method can be integrated into, embedded within, or communicatively coupled to a wide variety of consumer and industrial hardware platforms. For example, the AI device 100 can be implemented in a mobile terminal (e.g., a smartphone or tablet), a smart television, a connected home appliance (e.g., a smart refrigerator or oven), an autonomous robot, an infotainment system in a vehicle, or any other suitable electronic device capable of executing multi-step operations. By deploying the framework in these specific hardware contexts, the system can ensure that automated commands remain strictly bounded by the physical and logical constraints of their respective real world environments.

For example, the AI device 100 can be applied in a wide range of interactive applications including a smart home ecosystem, a digital web automation system, and a home robot. For example, according to an embodiment, the home robot can determine the physical constraints and spatial commonsense priors of a room, and based on this information, the robot can perform a more relevant navigating or retrieving action, such as executing complex multi-step object retrieval that more accurately addresses the physical realities of the user's environment without attempting logically invalid movements.

For example, methods and systems disclosed herein have broad applicability across a wide range of industries and technical fields that utilize autonomous task execution, robotic process automation (RPA), and sequential decision making. The logically grounded action trajectories generated by the disclosed neuro-symbolic multi-module framework can be well suited for deployment on resource constrained edge devices where deploying massive, power intensive large language models (LLMs) with hundreds of billions of parameters is prohibitive or computationally impractical.

Non-limiting examples of such applications include consumer electronics and smart home appliances, such as robotic vacuums, smart refrigerators, digital personal assistants, and interactive displays. The disclosed embodiments can allow manufacturers of such devices to rapidly and cost effectively develop and deploy advanced autonomous reasoning and task completion capabilities, utilizing explicit symbolic rules and progress tracking to accurately execute multi-step user commands without hallucinating nonexistent features or entering repetitive error loops.

Further, the disclosed method can provide significant advantages for the digital automation and software industry, where robust task execution is desirable for user experience and automated transaction processing. The trained framework can be integrated into web browsing agents or automated customer service systems to manage complex digital itineraries, online shopping checkouts, and database navigation. The ability to seamlessly fuse strict domain constitutions with temporal state tracking allows for the creation of highly reliable digital systems that can accurately progress through sequential web interfaces (e.g., guaranteeing an item is successfully placed in a cart before attempting to execute a checkout command) even when using an un-tuned language model.

In an enterprise or industrial context, the method can be used to develop and deploy specialized autonomous agents for warehouse robotics, automated inventory management, software testing, and supply chain logistics. This enables companies to build powerful operational tools that construct complete execution plans for complex, multi-stage industrial tasks, reliably navigating intricate domain constraints from a single unified prompt, thereby streamlining operations and reducing computational overhead.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, Python, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
receiving, by a processor in the AI device, a user query indicating a target task and an observation from a target environment;
obtaining, by the processor, a set of domain constraints, a set of contextual priors and state information based on the user query and the observation;
constructing an aggregated prompt sequence that fuses the user query and the observation with the set of domain constraints, the set of contextual priors, and the state information;
generating, by a large language model, an action based on the aggregated prompt sequence; and
outputting the action for execution within the target environment,
wherein the set of domain constraints and the set of contextual priors restrict an available action space of the large language model to prevent execution of impossible or contextually invalid operations.

2. The method of claim 1, wherein the obtaining the set of domain constraints, the set of contextual priors, and the state information includes:
parsing, by a manager module executed by the processor, the user query and the observation to extract an operational domain and at least one target entity; and
querying a plurality of independent symbolic modules based on the operational domain and the at least one target entity.

3. The method of claim 1, wherein the set of domain constraints is retrieved from an environment constitution module and defines rules, unalterable physical laws or boundaries of the target environment, and
wherein the set of domain constraints prunes physically impossible actions from the available action space of the large language model.

4. The method of claim 1, wherein the set of contextual priors is retrieved from a commonsense augmentation module including at least one of a lookup table, a database or a relational knowledge graph, and
wherein the set of contextual priors maps target objects to at least one of statistically probable locations, functional affordances, or relational prerequisites within the target environment to prevent contextually absurd actions or contextually absurd strategies.

5. The method of claim 1, wherein the state information is maintained by a progress tracking module configured as a finite state machine or programming logic, and
wherein the state information includes a sequential log of one or more of prior executed actions, current sub-goals, and intermediate thought checkpoints.

6. The method of claim 1, wherein the constructing the aggregated prompt sequence further includes:
injecting a predefined list of permissible action templates and a plurality of few-shot examples configured to teach the large language model a structured reasoning format.

7. The method of claim 6, wherein the structured reasoning format mandates that the large language model alternates between generating an intermediate thought validating a sub-goal and outputting the action based on a strict syntax defined by one of the permissible action templates.

8. The method of claim 1, further comprising:
receiving an updated observation from the target environment in response to the execution of the action;
updating the state information based on the updated observation;
obtaining an updated set of domain constraints, an updated set of contextual priors, and updated state information;
constructing an updated aggregated prompt sequence based on the updated set of domain constraints, the updated set of contextual priors, and the updated state information; and
generating a subsequent action based on the updated aggregated prompt sequence.

9. The method of claim 1, wherein the obtaining and the constructing are orchestrated by a meta large language model configured to dynamically evaluate the user query, autonomously retrieve the set of domain constraints and the set of contextual priors, and compile the aggregated prompt sequence before passing the aggregated prompt sequence to the large language model for inference.

10. The method of claim 1, wherein the target environment is a real world physical environment and the action is output as a motor control signal to a robotic apparatus, or
wherein the target environment is a digital environment and the action is output as an automated web browser interaction.

11. The method of claim 1, wherein the state information includes an execution step count or a repeated action counter, and
wherein the method further comprises:
monitoring the execution step count or the repeated action counter during execution of the target task;
comparing the execution step count or the repeated action counter with a predetermined threshold number; and
in response to determining that the execution step count or the repeated action counter exceeds the predetermined threshold number, modifying the aggregated prompt sequence to inject a corrective heuristic,
wherein the corrective heuristic forces the large language model to select an alternative action pathway to prevent the artificial intelligence device from entering an endless execution loop.

12. The method of claim 1, wherein the observation from the target environment includes visual data,
wherein the receiving the observation further includes:
processing the visual data through a vision-language model or an image encoder to extract a textual state description of the target environment, and
wherein the textual state description identifies objects and spatial geometries within the target environment and is fused into the aggregated prompt sequence to ground the large language model in a current physical reality of the target environment.

13. The method of claim 1, further comprising:
in response to the target environment returning an error observation indicating that the action failed to execute successfully, updating the state information to flag the action as a failed operation for a current environmental state, and constructing a subsequent aggregated prompt sequence that includes the failed operation and instructs the large language model to bypass the failed operation during a subsequent inference cycle.

14. An artificial intelligence (AI) device, comprising:
a memory configured to store information for a large language model; and
a controller configured to:
receive a user query indicating a target task and an observation from a target environment,
obtain a set of domain constraints, a set of contextual priors and state information based on the user query and the observation,
construct an aggregated prompt sequence that fuses the user query and the observation with the set of domain constraints, the set of contextual priors, and the state information,
generate, by the large language model, an action based on the aggregated prompt sequence, and
output the action for execution within the target environment,
wherein the set of domain constraints and the set of contextual priors restrict an available action space of the large language model to prevent execution of impossible or contextually invalid operations.

15. The AI device of claim 14, wherein the controller is further configured to:
retrieve the set of domain constraints from an environment constitution module, the set of domain constraints defining rules, unalterable physical laws or boundaries of the target environment, and
wherein the set of domain constraints prunes the available action space of the large language model.

16. The AI device of claim 14, wherein the controller is further configured to:
retrieve the set of contextual priors from a commonsense augmentation module including at least one of a lookup table, a database or a relational knowledge graph, and
wherein the set of contextual priors maps target objects to at least one of statistically probable locations, functional affordances, or relational prerequisites within the target environment to prevent contextually absurd actions or strategies.

17. The AI device of claim 14, wherein the state information is maintained by a progress tracking module configured as a finite state machine or programming logic, and
wherein the state information includes a sequential log of one or more of prior executed actions, current sub-goals, and intermediate thought checkpoints.

18. The AI device of claim 14, wherein the controller is further configured to:
inject a predefined list of permissible action templates and a plurality of few-shot examples configured to teach the large language model a structured reasoning format to construct the aggregated prompt sequence, and
wherein the structured reasoning format mandates that the large language model alternates between generating an intermediate thought validating a sub-goal and outputting the action based on a strict syntax defined by one of the permissible action templates.

19. The AI device of claim 14, wherein the state information includes an execution step count or a repeated action counter,
wherein the controller is further configured to:
monitor the execution step count or the repeated action counter during execution of the target task,
compare the execution step count or the repeated action counter with a predetermined threshold number, and
in response to determining that the execution step count or the repeated action counter exceeds the predetermined threshold number, modify the aggregated prompt sequence to inject a corrective heuristic, and
wherein the corrective heuristic forces the large language model to select an alternative action pathway to prevent the artificial intelligence device from entering an endless execution loop.

20. A non-transitory computer readable medium storing computer-executable instructions that when executed by a processor, cause the processor to perform the operations of:
receiving a user query indicating a target task and an observation from a target environment;
obtaining a set of domain constraints, a set of contextual priors, and state information based on the user query and the observation;
constructing an aggregated prompt sequence that fuses the user query and the observation with the set of domain constraints, the set of contextual priors, and the state information;
generating, by a large language model, an action based on the aggregated prompt sequence; and
outputting the action for execution within the target environment,
wherein the set of domain constraints and the set of contextual priors restrict an available action space of the large language model to prevent execution of impossible or contextually invalid operations.
